(19) United States
(12) Patent Application Publication
(10) Pub. No.: US 2025/0317852 A1
(43) Pub. Date: Oct. 9, 2025

(54) METHOD AND APPARATUS FOR AWAKENING NETWORK DEVICE, DEVICE, AND STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/869,654

(22) PCT Filed: Jun. 2, 2022
(86) PCT No.: PCT/CN2022/096961

§ 371 Date: Nov. 26, 2024

(51) Int. Cl. H04W 52/02; H04B 17/318; H04W 52/28

(52) U.S. Cl. CPC H04W 52/0229; H04B 17/328; H04W 52/283

(57) ABSTRACT

A method for awakening a network device, including: determining configuration information, the configuration information includes power parameter information; and sending the configuration information to a user equipment, where the power parameter information is used for indicating transmit power at which the user equipment sends an awakening signal to N second network devices, N is a positive integer, and N is greater than or equal to 1.

### CROSS-REFERENCE TO RELATED APPLICATIONS

The present application is a U.S. National Stage of International Application No. PCT/CN2022/096961, filed on PCT Jun. 2, 2022, the contents of all of which are incorporated herein by reference in their entireties for all purposes

### BACKGROUND

Currently, a method to reduce energy consumption of a base station is to reduce needless downlink transmission. A manner to reduce the downlink transmission is to make the base station in a dormant state. The base station in the dormant state stops downlink sending, but has an uplink reception function and can receive an awakening signal sent by a terminal. When needing to perform a communication service, the user equipment needs to send the awakening signal to the dormant base station. After receiving the awakening signal, the base station will resume normal transceiving functions, and provide the communication service for the UE.

### SUMMARY

The disclosure relates to the technical field of wireless communications, in particular to a method and apparatus for awakening a network device, a device and a storage medium

According to a first aspect of an example of the disclosure, a method for awakening a network device is provided and performed by a first network device and includes:
determining configuration information, the configuration information including power parameter information; and
sending the configuration information to user equipment;
where, the power parameter information is used for indicating transmit power at which the user equipment sends an awakening signal to N second network devices, N is a positive integer, and N is greater than or equal to 1.

According to a second aspect of an example of the disclosure, a method for awakening a network device is provided and performed by user equipment and includes:
receiving configuration information from a first network device, the configuration information including power parameter information;
where, the power parameter information is used for indicating transmit power at which the user equipment sends an awakening signal to N second network devices, N is a positive integer, and N is greater than or equal to 1.

According to a third aspect of an example of the disclosure, a method for awakening a network device is provided and performed by a second network device and includes:
receiving an awakening signal from user equipment;
determining signal quality indication information of the awakening signal; and
determining to awaken the second network device in response to a signal quality indicated by the signal quality indication information being greater than a set threshold.

According to a fourth aspect of an example of the disclosure, a network side device is provided, and includes:
one or more processors; and
a memory, configured to store executable instructions of one or more processors;
where, the one or more processors are collectively configured to execute the executable instructions in the memory so as to implement steps of the method for awakening the network device according to the first aspect of an example of the disclosure.

According to a fifth aspect of an example of the disclosure, a mobile terminal is provided, and includes:
one or more processors; and
a memory, configured to store executable instructions of the one or more processors;
where, the one or more processors are collectively configured to execute the executable instructions in the memory so as to implement steps of the method for awakening the network device according to the second aspect of an example of the disclosure.

According to a sixth aspect of an example of the disclosure, a network side device is provided, and includes:
one or more processors; and
a memory, configured to store executable instructions of the one or more processors;
where, the one or more processors are collectively configured to execute the executable instructions in the memory so as to implement steps of the method for awakening the network device according to the third aspect of an example of the disclosure.

According to a seventh aspect of an example of the disclosure, a non-temporary computer-readable storage medium is provided, and stores executable instructions, and the executable instructions, when executed by one or more processors, implement steps of the method for awakening the network device above.

It is to be understood that the above general description and the following detailed description are for illustration and explanatory, and cannot limit the disclosure.

### BRIEF DESCRIPTION OF DRAWINGS

Accompanying drawings illustrated here are used for providing a further understanding of the examples of the disclosure, and constitute a part of the present disclosure. The schematic examples and their explanations of the examples of the disclosure are used for explaining the examples of the disclosure and do not constitute an improper limitation on the examples of the disclosure. In the figures:

the accompanying drawings here, which are incorporated in and constitute a part of this specification, illustrate examples consistent with the examples of the disclosure and together with the specification, serve to explain the principles of the examples of the disclosure.

FIG. 1 is a schematic diagram of an architecture of a wireless communication system shown according to an example.

FIG. 2 is a flow diagram of a method for awakening a network device shown according to an example.

FIG. 3 is a flow diagram of a method for awakening a network device shown according to an example.

FIG. 4 is a flow diagram of a method for awakening a network device shown according to an example.

FIG. 5 is a flow diagram of a method for awakening a network device shown according to an example.

FIG. 6 is a flow diagram of a method for awakening a network device shown according to an example.

FIG. 7 is a flow diagram of a method for awakening a network device shown according to an example.

FIG. 8 is a flow diagram of a method for awakening a network device shown according to an example.

FIG. 9 is a block diagram of an apparatus for awakening a network device shown according to an example.

FIG. 10 is a block diagram of an apparatus for awakening a network device shown according to an example.

FIG. 11 is a block diagram of an apparatus for awakening a network device shown according to an example.

FIG. 12 is a structural diagram of an apparatus for awakening a network device shown according to an example.

FIG. 13 is a structural diagram of an apparatus for awakening a network device shown according to an example.

### DETAILED DESCRIPTION

Examples of the disclosure are now further illustrated with reference to accompanying drawings and specific implementations.

Examples will be illustrated in detail here, instances of which are represented in the accompanying drawings. When the following descriptions refer to the accompanying drawings, the same number in the different accompanying drawings represents the same or similar elements unless otherwise indicated. The implementations described in the following examples do not represent all implementations consistent with the examples of the disclosure. On the contrary, they are examples of an apparatus and method consistent with some aspects of the disclosure as detailed in the appended claims.

Terms used in the examples of the disclosure are for the purpose of describing the particular examples, and are not intended to limit the examples of the disclosure. The singular forms “a” and “this” used in the examples of the disclosure and the appended claims are intended to include the plural forms as well, unless the context clearly indicates otherwise. It is to be further understood that a term “and/or” used in this text refers to and contains any or all possible combinations of one or more associated listed items.

It should be understood that the terms “first”, “second”, “third” and the like may be employed in the examples of the disclosure to describe various information, but these pieces of information should not be limited to these terms. These terms are used to distinguish the same type of information from one another. For example, in a case of not departing from the scope of the examples of the disclosure, first information may also be called second information, and similarly, the second information may also be called the first information. Depending on the context, the word “if” and “in case” as used here may be interpreted as “at the time of” or “when” or “in response to determining”.

Examples of the disclosure are described below in detail. Examples of the examples are shown in the accompanying drawings. The same or similar reference numbers represent the same or similar elements from beginning to end. The examples described below with reference to the accompanying drawings are examples, aim to explain the disclosure, and cannot be understood as limitation to the disclosure.

In view of this, the disclosure provides a method and apparatus for awakening a network device, a device, and a storage medium.

As shown in FIG. 1, a method for awakening a network device provided by an example of the disclosure may be applied to a wireless communication system 100, and the wireless communication system may include, but is not limited to a network device 101 and user equipment 102. The user equipment 102 is configured to support carrier aggregation, and the user equipment 102 may be connected to a plurality of carrier units of the network device 101, including a primary carrier unit and one or more secondary carrier units.

It is to be understood that the above wireless communication system 100 may be applied to both a low-frequency scenario and a high-frequency scenario. Application scenarios of the wireless communication system 100 include, but are not limited to a long term evolution (LTE) system, an LTE frequency division duplex (FDD) system, an LTE time division duplex (TDD) system, a worldwide interoperability for microwave access (WiMAX) communication system, a cloud radio access network (CRAN) system, a future 5th-generation (5G) system, a new radio (NR) communication system, or a future evolved public land mobile network (PLMN) system, and the like.

The user equipment 102 shown above may be a user equipment (UE), a terminal, an access terminal, a terminal unit, a terminal station, a mobile station (MS), a remote station, a remote terminal, a mobile terminal, a wireless communication device, a terminal agent, or a user device, and the like. The user equipment 102 may have wireless transceiving functions, and can communicate with one or more network devices 101 of one or more communication systems (such as wireless communication) and receive network services provided by the network device 101. The network device 101 here includes, but is not limited to an illustrated base station.

The user equipment 102 may be a cellular phone, a cordless phone, a session initiation protocol (SIP) phone, a wireless local loop (WLL) station, a personal digital assistant (PDA) device, a handheld device with a wireless communication function, a computing device or other processing devices connected to a wireless modem, a vehicle-mounted device, a wearable device, user equipment in a future 5G network, or user equipment in a future evolved PLMN network.

The network device 101 may be an access network device (or an access network site). The access network device refers to a device that provides a network access function, such as a radio access network (RAN) base station and so on. The network device may specifically include a base station (BS) device, or include the base station device and a wireless resource management device for controlling the base station device. The network device may further include a relay station (a relay device), an access point, a base station in the future 5G network, a base station in the future evolved PLMN network, or an NR base station. The network device may be a wearable device or a vehicle-mounted device. The network device may also be a communication chip with a communication module.

For example, the network device 101 includes, but is not limited to: a next-generation base station (gnodeB, gNB) in 5G, an evolved node B (eNB) in the LTE system, a radio network controller (RNC), a node B (NB) in a WCDMA system, a wireless controller in a CRAN system, a base station controller (BSC), a base transceiver station (BTS) in a GSM system or the CDMA system, a home base station (e.g., a home evolved nodeB, or a home node B (HNB)), a baseband unit (BBU), a transmitting and receiving point (TRP), a transmitting point (TP), or a mobile switching center.

A manner of the UE sending an uplink awakening signal to awaken the base station may be used in a heterogeneous network or a homogeneous network. In the heterogeneous network, there are several small cells under wide area coverage of a macro cell, and the small cells are used for coverage enhancement or hotspot coverage, where coverage ranges of the small cells are within a coverage range of the macro cell. In the homogeneous network, the coverage ranges of adjacent base stations do not overlap.

In the above mechanism that the UE sends the uplink awakening signal to awaken the base station, a plurality of base stations in a dormant state may receive the awakening signal.

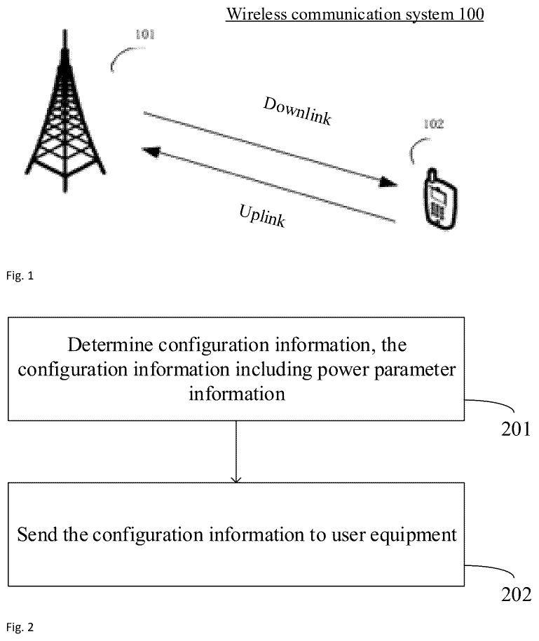

An example of the disclosure provides a method for awakening a network device, and the method is performed by a first network device. FIG. 2 is a flow diagram of a method for awakening a network device shown according to an example. As shown in FIG. 2, the method includes:
step 201, configuration information is determined, the configuration information including power parameter information; and
step 202, the configuration information is sent to user equipment;
where, the power parameter information is used for indicating transmit power at which the user equipment sends an awakening signal to N second network devices, N is a positive integer, and N is greater than or equal to 1.

In an implementation, a first network device is, for example, a macro cell, and the second network devices are, for example, small cells. The awakening signal is sent by the user equipment to the second network devices, namely the small cells, to awaken the second network devices. The first network device, namely the macro cell, configures the transmit power for the user equipment to send the awakening signal above. The second network devices determine a quality of a channel between the second network devices and the user equipment based on the awakening signal received from the user equipment, so as to determine whether the second network devices are awakened.

It is to be noted that for a heterogeneous network scenario, the small cells may be in a dormant state. If the quality of the channel from the user equipment to the small cells is good, the small cells are turned on; otherwise, the small cells are not turned on.

In an implementation, the configuration information for the user equipment is determined by the first network device, the configuration information includes the power parameter information, and the power parameter information is used for indicating the transmit power at which the user equipment sends the awakening signal to one or more second network devices. Then, the determined configuration information is sent by the first network device to the user equipment, so that the user equipment sends the awakening signal to the second network devices based on the transmit power indicated by the configuration information.

In the above implementation, the first network device configures the transmit power for the user equipment to send the awakening signal to the second network devices, and sends the configuration information to the user equipment. The user equipment sends the awakening signal based on the configured transmit power. Thus, the second network devices can determine the quality of the channel between the second network devices and the user equipment based on the awakening signal received from the user equipment, so as to determine whether the second network devices are awakened.

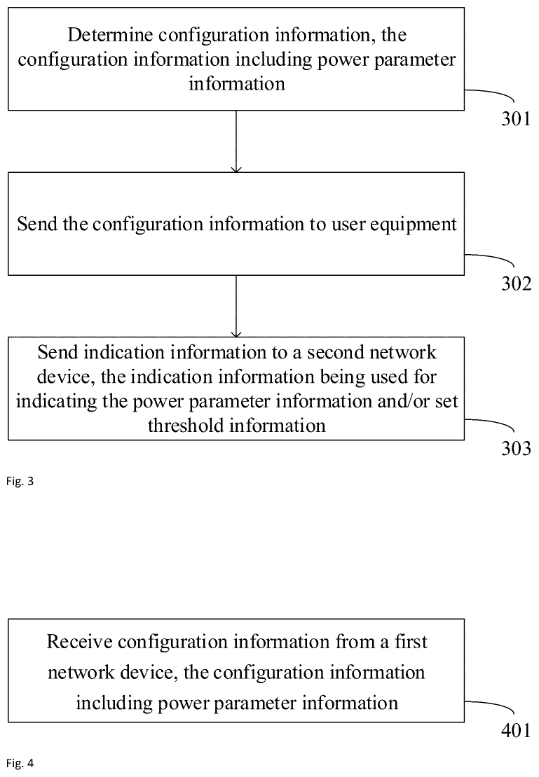

An example of the disclosure provides a method for awakening a network device, and the method is performed by a first network device. The method may be executed independently or in combination with any other example in the examples of the disclosure. FIG. 3 is a flow diagram of a method for awakening a network device shown according to an example. As shown in FIG. 3, the method includes:
step 301, configuration information is determined, the configuration information including power parameter information; and
step 302, the configuration information is sent to user equipment; and
step 303, indication information is sent to the second network devices, the indication information being used for indicating the power parameter information or set threshold information;
where, the power parameter information is used for indicating transmit power at which the user equipment sends an awakening signal to N second network devices, N is a positive integer and N is greater than or equal to 1, and the set threshold information is used for determining whether to awaken the second network devices.

In an implementation, the configuration information for the user equipment is determined by the first network device, the configuration information includes the power parameter information, and the power parameter information is used for indicating the transmit power at which the user equipment sends the awakening signal to one or more second network devices. Then, the determined configuration information is sent by the first network device to the user equipment, so that the user equipment sends the awakening signal to the second network device based on the transmit power indicated by the configuration information. The first network device further sends the above power parameter information or set threshold information to the second network devices by sending the indication information to the second network devices.

It is to be noted that after receiving the awakening signal sent by the user equipment, the second network devices may acquire signal quality indication information of the awakening signal. Through the signal quality indication information and the transmit power of the awakening signal, a quality of a channel between the second network devices and the user equipment may be determined. Thus, when the channel quality is good, the second network devices are determined to be turned on, and when the channel quality is poor, the second network devices are kept in a dormant state.

In an implementation, the indication information sent by the first network device is used for indicating the power parameter information above, so that the second network devices determine the transmit power at which the user equipment sends the awakening signal to the second network devices based on the power parameter information. In an implementation, the indication information sent by the first network device is used for indicating the set threshold information, and the set threshold information includes a set threshold regarding a signal quality. For example, when the signal quality indication information includes signal receiving power, the set threshold is a set power threshold, and the channel quality is judged by comparing the signal receiving power with the set power threshold. When the signal quality indication information includes a signal receiving quality, the set threshold is a set quality threshold, and the channel quality is judged by comparing the signal receiving quality with the set quality threshold.

In the above implementation, the first network device configures the transmit power for the user equipment to send the awakening signal to the second network devices, and sends the configuration information to the user equipment. Furthermore, the first network device further sends the power parameter information or the set threshold information for judging the channel quality to the second network devices. The user equipment sends the awakening signal based on the configured transmit power. Thus, the second network devices can determine the quality of the channel between the second network devices and the user equipment based on the awakening signal received from the user equipment, so as to determine whether the second network devices are awakened.

An example of the disclosure provides a method for awakening a network device, and the method is performed by a first network device. The method may be executed independently or in combination with any other example in the examples of the disclosure. The method includes:
configuration information is determined, the configuration information including power parameter information; and
the configuration information is sent to user equipment;
where, the power parameter information is used for indicating transmit power at which the user equipment sends an awakening signal to N second network devices, N is a positive integer, and N is greater than or equal to 1; and the power parameter information includes M power parameters, M is a positive integer, and being greater than or equal to M, M being greater than or equal to 1.

In an implementation, configuration information for the user equipment is determined by a first network device, the configuration information includes the power parameter information, and the power parameter information is used for indicating the transmit power at which the user equipment sends the awakening signal to one or more second network devices. The power parameter information may indicate one transmit power or the plurality of transmit power. Then, the determined configuration information is sent by the first network device to the user equipment, so that the user equipment sends the awakening signal to the second network devices based on the transmit power indicated by the configuration information.

In an implementation, in response to M being equal to 1, the power parameter information is used for indicating that the user equipment uses the same transmit power when sending the awakening signal to the N second network devices; and in response to N being greater than or equal to 2 and N is greater than or equal to M, M is greater than or equal to 2, the power parameter information is used for indicating that the user equipment uses different transmit power when sending the awakening signal to at least two second network devices. The following several conditions are specifically included:

N is equal to 1, and M is equal to 1. The configuration information for the user equipment is determined by the first network device, the configuration information includes the power parameter information, and the power parameter information is used for indicating the transmit power at which the user equipment sends the awakening signal to one second network device. At this time, the power parameter information indicates one transmit power. Then, the determined configuration information is sent by the first network device to the user equipment, so that the user equipment sends the awakening signal to one second network device above based on one transmit power indicated by the configuration information.

N is greater than 1, and M is equal to 1. The configuration information for the user equipment is determined by the first network device, the configuration information includes the power parameter information, and the power parameter information is used for indicating the transmit power at which the user equipment sends the awakening signal to the plurality of second network devices. At this time, the power parameter information indicates one transmit power. Then, the determined configuration information is sent by the first network device to the user equipment, so that the user equipment sends the awakening signal to the plurality of second network devices above based on one transmit power indicated by the configuration information. In the implementation, the first network device configures one transmit power for the user device, and the user equipment uses the same transmit power when sending the awakening signal to the plurality of second network devices.

N is greater than 1, and M is equal to N. The configuration information for the user equipment is determined by the first network device, the configuration information includes the power parameter information, and the power parameter information is used for indicating the transmit power at which the user equipment sends the awakening signal to the plurality of second network devices. At this time, the power parameter information indicates the plurality of transmit power, and the quantity of the indicated transmit power is equal to the quantity of the second network devices that receive the awakening signal sent by the user equipment. Then, the determined configuration information is sent by the first network device to the user equipment, so that the user equipment respectively sends the awakening signal to the plurality of second network devices above based on the plurality of transmit power indicated by the configuration information. In the implementation, the first network device configures the plurality of transmit power for the user equipment, that is, the first network device configures one transmit power for each second network device that receives the awakening signal sent by the user equipment. It is to be noted that the plurality of configured transmit power may be the same or different.

N is greater than 1, and M is less than N. The configuration information for the user equipment is determined by the first network device, the configuration information includes the power parameter information, and the power parameter information is used for indicating the transmit power at which the user equipment sends the awakening signal to the plurality of second network devices. At this time, the power parameter information indicates the plurality of transmit power, and the quantity of the indicated transmit power is less than the quantity of the second network devices that receive the awakening signal sent by the user equipment. Then, the determined configuration information is sent by the first network device to the user equipment, so that the user equipment sends the awakening signal to one second network device above based on one transmit power indicated by the configuration information. In the implementation, the quantity of the transmit power configured by the first network device for the user equipment is less than the quantity of the second network devices that receive the awakening signal sent by the user equipment, that is, for the plurality of second network devices, the first network device configures the same transmit power for the user equipment.

In the above implementation, the first network device configures the transmit power for the user equipment to send the awakening signal to the second network devices, and sends the configuration information to the user equipment. The user equipment sends the awakening signal based on the configured transmit power. Thus, the second network devices can determine a quality of a channel between the second network devices and the user equipment based on the awakening signal received from the user equipment, so as to determine whether the second network devices are awakened.

An example of the disclosure provides a method for awakening a network device, and the method is performed by a first network device. The method may be executed independently or in combination with any other example in the examples of the disclosure. The method includes:
configuration information is determined, the configuration information including power parameter information, where based on a coverage range of each of N second network devices, transmit power at which user equipment sends an awakening signal to each second network device is determined; and
the configuration information is sent to the user equipment;
where, the power parameter information is used for indicating transmit power at which the user equipment sends the awakening signal to the N second network devices, N is a positive integer, and N is greater than or equal to 1.

In an implementation, the configuration information for the user equipment is determined by the first network device, the configuration information includes the power parameter information, and the power parameter information is used for indicating the transmit power at which the user equipment sends the awakening signal to one or more second network devices. Based on the coverage range of each of the second network devices, the transmit power at which the user equipment sends the awakening signal to each second network device is determined by the first network device. Then, the determined configuration information is sent by the first network device to the user equipment, so that the user equipment sends the awakening signal to the second network devices based on the transmit power indicated by the configuration information.

It is to be noted that if a coverage range of each small cell under a macro cell is similar in a network planning, the same transmit power may be configured for the user equipment to send the awakening signal to these small cells. If some small cells have a larger coverage range while others have a smaller coverage range, larger transmit power is configured for the small cells with the larger coverage ranges, and smaller transmit power is configured for the small cells with the smaller coverage ranges.

In the above implementation, the first network device configures the transmit power for the user equipment to send the awakening signal to the second network devices, and sends the configuration information to the user equipment. The user equipment sends the awakening signal based on the configured transmit power. Thus, the second network devices can determine a quality of a channel between the second network devices and the user equipment based on the awakening signal received from the user equipment, so as to determine whether the second network devices are awakened.

An example of the disclosure provides a method for awakening a network device, and the method is performed by a first network device. The method may be executed independently or in combination with any other example in the examples of the disclosure. The method includes:
configuration information is determined, the configuration information including power parameter information; and
the configuration information is sent to user equipment;
where, the power parameter information is used for indicating transmit power at which the user equipment sends an awakening signal to N second network devices, N is a positive integer, and N is greater than or equal to 1;
and where, in response to that the awakening signal carries identity information of second network devices to be awakened, the power parameter information includes N power parameters, the N power parameters are in one-to-one correspondence with the N second network devices, and the N power parameters are the same or different.

In an implementation, the configuration information for the user equipment is determined by the first network device, the configuration information includes the power parameter information, and the power parameter information is used for indicating the transmit power at which the user equipment sends the awakening signal to one or more second network devices. When the awakening signal sent by the user equipment carries the identity information of the second network devices to be awakened, for each second network device to be awakened, the first network device configures the transmit power for the user equipment. Then, the determined configuration information is sent by the first network device to the user equipment, so that the user equipment sends the awakening signal to the second network devices based on the transmit power indicated by the configuration information.

It is to be noted that for each second network device to be awakened, the first network device configures the transmit power for the user equipment, and the plurality of configured transmit power may be the same or different. For example, when a coverage range of each second network device to be awakened is similar in size, the plurality of transmit power configured by the first network device may be the same.

In the above implementation, the first network device configures the transmit power for the user equipment to send the awakening signal to the second network devices, and sends the configuration information to the user equipment. The user equipment sends the awakening signal based on the configured transmit power. Thus, the second network devices can determine a quality of a channel between the second network devices and the user equipment based on the awakening signal received from the user equipment, so as to determine whether the second network devices are awakened.

An example of the disclosure provides a method for awakening a network device, and the method is performed by user equipment. FIG. 4 is a flow diagram of a method for awakening a network device shown according to an example. As shown in FIG. 4, the method includes:
step 401, configuration information from a first network device is received, the configuration information including power parameter information;
where, the power parameter information is used for indicating transmit power at which user equipment sends an awakening signal to N second network devices, N is a positive integer, and N is greater than or equal to 1.

In an implementation, a first network device is, for example, a macro cell, and the second network devices are, for example, small cells. The awakening signal is sent by the user equipment to the second network devices, namely the small cells, to awaken the second network devices. The first network device, namely the macro cell, configures the transmit power for the user equipment to send the awakening signal above. The second network devices determine a quality of a channel between the second network devices and the user equipment based on the awakening signal received from the user equipment, so as to determine whether the second network devices are awakened.

It is to be noted that for a heterogeneous network scenario, the small cells may be in a dormant state. If the quality of the channel from the user equipment to the small cells is good, the small cells are turned on; otherwise, the small cells are not turned on.

In an implementation, the determined configuration information is sent by the first network device to the user equipment, the configuration information includes the power parameter information, and the power parameter information is used for indicating the transmit power at which the user equipment sends the awakening signal to one or more second network devices. The user equipment receives the configuration information, so as to send the awakening signal to the second network devices based on the transmit power indicated by the configuration information.

In the above implementation, the first network device configures the transmit power for the user equipment to send the awakening signal to the second network devices, and sends the configuration information to the user equipment. The user equipment sends the awakening signal based on the configured transmit power. Thus, the second network devices can determine a quality of a channel between the second network devices and the user equipment based on the awakening signal received from the user equipment, so as to determine whether the second network devices are awakened.

An example of the disclosure provides a method for awakening a network device, and the method is performed by user equipment. The method may be executed independently or in combination with any other example in the examples of the disclosure. FIG. 5 is a flow diagram of a method for awakening a network device shown according to an example. As shown in FIG. 5, the method includes:
step 501, configuration information from a first network device is received, the configuration information including power parameter information; and
step 502, an awakening signal is sent to at least one of N second network devices based on the power parameter information;
where, the power parameter information is used for indicating transmit power at which user equipment sends the awakening signal to the N second network devices, N is a positive integer, and N is greater than or equal to 1.

In an implementation, the determined configuration information is sent by the first network device to the user equipment, the configuration information includes the power parameter information, and the power parameter information is used for indicating the transmit power at which the user equipment sends the awakening signal to one or more second network devices. The user equipment receives the configuration information, and sends the awakening signal to at least one of the second network devices based on the transmit power indicated by the configuration information.

In an implementation, sending, by the user equipment, the awakening signal to at least one of the N second network devices includes: sending the awakening signal to each of the at least one second network device for L times within a first set time period, where L is a positive integer, and L is greater than or equal to 2. A duration of the first set time period may be indicated by the first network device or determined based on an agreement of a communication protocol.

During a certain period of time, the user equipment sends the awakening signal for multiple times to facilitate evaluation of an average channel state by the second network devices, and thus determine a channel quality more accurately.

In an implementation, the determined configuration information is sent by the first network device to the user equipment, the configuration information includes the power parameter information, and the power parameter information is used for indicating the transmit power at which the user equipment sends the awakening signal to one or more second network devices. The power parameter information may indicate one transmit power or the plurality of transmit power. The user equipment receives the configuration information, and sends the awakening signal to at least one of the second network devices based on the transmit power indicated by the configuration information. That is, the power parameter information includes M power parameters, M is a positive integer, and N being greater than or equal to M, M being greater than or equal to 1.

It is to be noted that although the power parameter information received by the user equipment indicates the transmit power at which the user equipment sends the awakening signal to the plurality of second network devices, the user equipment may also send the awakening signal to one or part of the second network devices among the plurality of second network devices. That is, the user equipment may not necessarily send the awakening signal to all of the second network devices among the plurality of second network devices.

In an implementation, sending, by the user equipment, the awakening signal to at least one of the N second network devices includes: in response to M being equal to 1, the user equipment uses the same transmit power when sending the awakening signal to the at least one second network device; and in response to being greater than or equal to 2, N being greater than or equal to M, M being greater than or equal to 2, and the at least one second network device being at least two second network devices, the user equipment uses different transmit power when sending the awakening signal to the at least two second network devices.

The following several conditions are specifically included:
N is equal to 1, and M is equal to 1. The configuration information sent by the first network device includes the power parameter information, and the power parameter information is used for indicating the transmit power at which the user equipment sends the awakening signal to one second network device. At this time, the power parameter information indicates one transmit power. The user equipment receives the configuration information above, and sends the awakening signal to one second network device above based on one transmit power indicated by the configuration information.
N is greater than 1, and M is equal to 1. The configuration information sent by the first network device includes the power parameter information, and the power parameter information is used for indicating the transmit power at which the user equipment sends the awakening signal to the plurality of second network devices. At this time, the power parameter information indicates one transmit power. The user equipment receives the configuration information above, and sends the awakening signal to at least one second network device based on one transmit power indicated by the configuration information. In the implementation, the first network device configures one transmit power for the user device, and the user equipment uses the same transmit power when sending the awakening signal to the plurality of second network devices.
N is greater than 1, and M is equal to N. The configuration information sent by the first network device includes the power parameter information, and the power parameter information is used for indicating the transmit power at which the user equipment sends the awakening signal to the plurality of second network devices. At this time, the power parameter information indicates the plurality of transmit power, and the quantity of the indicated transmit power is equal to the quantity of the second network devices that receive the awakening signal sent by the user equipment. The user equipment receives the configuration information above, and sends the awakening signal to at least one second network device based on the transmit power indicated by the configuration information. In the implementation, the first network device configures one transmit power for each second network device that receives the awakening signal sent by the user equipment, and the user equipment sends the awakening signal based on the transmit power corresponding to the second network device that receives the awakening signal. It is to be noted that the plurality of configured transmit power may be the same or different.
N is greater than 1, and M is less than N. The configuration information sent by the first network device includes the power parameter information, and the power parameter information is used for indicating the transmit power at which the user equipment sends the awakening signal to the plurality of second network devices. At this time, the power parameter information indicates the plurality of transmit power, and the quantity of the indicated transmit power is less than the quantity of the second network devices that receive the awakening signal sent by the user equipment. The user equipment receives the configuration information above, and sends the awakening signal to at least one second network device based on the transmit power indicated by the configuration information. In the implementation, the quantity of the transmit power configured by the first network device for the user equipment is less than the quantity of the second network devices that receive the awakening signal sent by the user equipment, that is, for the plurality of second network devices, the first network device configures the same transmit power for the user equipment.

In an implementation, sending, by the user equipment, the awakening signal to at least one of the N second network devices includes: in response to that the awakening signal carries identity information of second network devices to be awakened, the awakening signal is sent to the at least one second network device based on transmit power indicated by a power parameter corresponding to the at least one second network device.

When the awakening signal sent by the user equipment carries the identity information of the second network devices to be awakened, for each second network device to be awakened, the first network device configures the transmit power for the user equipment. Thus, when the user equipment sends the awakening signal to one second network device to be awakened, sending of the awakening signal is executed based on the transmit power configured by the first network device for the second network device.

In the above implementation, the first network device configures the transmit power for the user equipment to send the awakening signal to the second network devices, and sends the configuration information to the user equipment. The user equipment sends the awakening signal based on the configured transmit power. Thus, the second network devices can determine a quality of a channel between the second network devices and the user equipment based on the awakening signal received from the user equipment, so as to determine whether the second network devices are awakened.

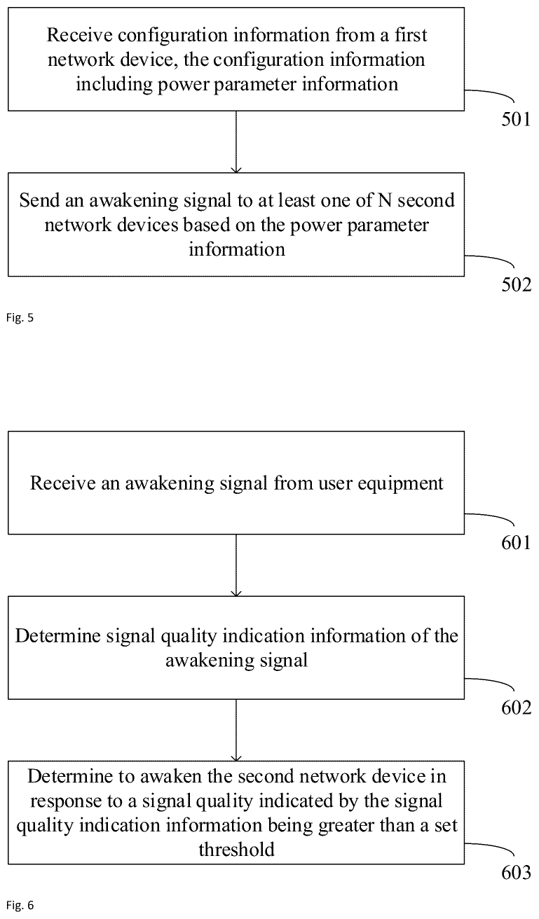

An example of the disclosure provides a method for awakening a network device, and the method is performed by a second network device. FIG. 6 is a flow diagram of a method for awakening a network device shown according to an example. As shown in FIG. 6, the method includes:
step 601, an awakening signal from user equipment is received;
step 602, signal quality indication information of the awakening signal is determined; and
step 603, it is determined to awaken a second network device in response to a signal quality indicated by the signal quality indication information being greater than a set threshold.

In an implementation, a first network device is, for example, a macro cell, and the second network device is, for example, a small cell. The awakening signal is sent by the user equipment to the second network device, namely the small cell, to awaken the second network device. The first network device, namely the macro cell, configures transmit power for the user equipment to send the awakening signal above. The second network device determines a quality of a channel between the second network device and the user equipment based on the awakening signal received from the user equipment, so as to determine whether the second network device is awakened.

It is to be noted that for a heterogeneous network scenario, the small cell may be in a dormant state. If the quality of the channel from the user equipment to the small cell is good, the small cell is turned on; otherwise, the small cell is not turned on.

In an implementation, the second network device receives the awakening signal sent by the user equipment and determines the signal quality indication information of the awakening signal. If a signal quality indicated by the signal quality indication information is greater than a set threshold, it indicates that the quality of the channel between the user equipment and the second network device is good, and thus it is determined to awaken the second network device.

In an implementation, receiving, by the second network device, the awakening signal from the user equipment includes: the L awakening signals sent by the user equipment are received within a first set time period, where L is a positive integer, and L is greater than or equal to 2.

In an implementation, determining the signal quality indication information of the awakening signal includes: average signal quality indication information of the L awakening signals is determined.

The user equipment sends the awakening signal for multiple times within a certain period of time, so that the second network device receives the awakening signal for multiple times, which facilitates the second network device to evaluate an average channel condition between the user equipment and the second network device, and thus more accurately determine the quality of the channel between the user equipment and the second network device.

It is to be noted that if the second network device is not configured with or does not receive information about the above set threshold, the second network device may execute an awakening signal operation after receiving the awakening signal sent by the user equipment, that is, the judgment on whether the signal quality is greater than the set threshold is not executed.

In the above implementation, the first network device configures the transmit power for the user equipment to send the awakening signal to the second network device, and sends the configuration information to the user equipment. The user equipment sends the awakening signal based on the configured transmit power. Thus, the second network device can determine the quality of the channel between the second network device and the user equipment based on the awakening signal received from the user equipment, so as to determine whether the second network device is awakened.

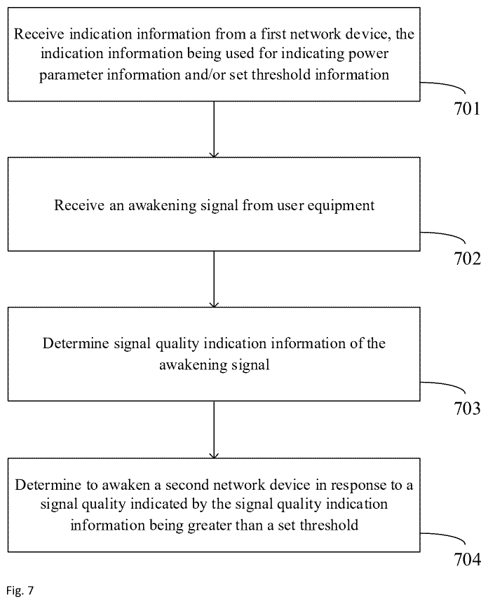

An example of the disclosure provides a method for awakening a network device, and the method is performed by a second network device. The method may be executed independently or in combination with any other example in the examples of the disclosure. FIG. 7 is a flow diagram of a method for awakening a network device shown according to an example. As shown in FIG. 7, the method includes:
step 701, indication information from a first network device is received, the indication information being used for indicating power parameter information or set threshold information;
step 702, an awakening signal from user equipment is received;
step 703, signal quality indication information of the awakening signal is determined; and
step 704, it is determined to awaken a second network device in response to a signal quality indicated by the signal quality indication information being greater than a set threshold;
where, the power parameter information is used for indicating transmit power at which the user equipment sends the awakening signal to the second network device.

In an implementation, the indication information from the first network device is received by the second network device, and the indication information is used for indicating the power parameter information or the set threshold information. The awakening signal sent by the user equipment is received by the second network device, and the signal quality indication information of the awakening signal is determined. If the signal quality indicated by the signal quality indication information is greater than the set threshold, it indicates that a quality of a channel between the user equipment and the second network device is good, and thus it is determined to awaken the second network device.

It is to be noted that the above step of receiving the indication information from the first network device is not limited to being executed before the step of receiving the awakening signal from the user equipment.

In an implementation, in response to determining that the indication information is used for indicating the power parameter information, the set threshold is determined by the second network device based on the power parameter information. The second network device needs to determine the channel quality based on the set threshold, so the set threshold may be determined based on the power parameter information.

In an implementation, the indication information is used for indicating the set threshold information, and the set threshold information includes the set threshold regarding the signal quality. For example, when the set threshold is a set power threshold, the signal quality indication information includes signal receiving power, and the channel quality is judged by comparing the signal receiving power with the set power threshold. When the set threshold is a set quality threshold, the signal quality indication information includes a signal receiving quality, and the channel quality is judged by comparing the signal receiving quality with the set quality threshold.

In the above implementation, the first network device configures the transmit power for the user equipment to send the awakening signal to the second network device, and sends the configuration information to the user equipment. The user equipment sends the awakening signal based on the configured transmit power. Thus, the second network device can determine the quality of the channel between the second network device and the user equipment based on the awakening signal received from the user equipment, so as to determine whether the second network device is awakened.

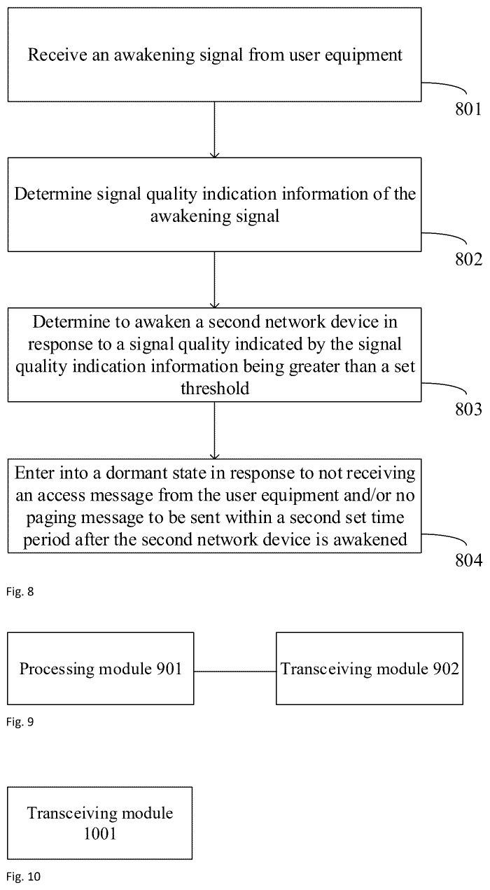

An example of the disclosure provides a method for awakening a network device, and the method is performed by a second network device. The method may be executed independently or in combination with any other example in the examples of the disclosure. FIG. 8 is a flow diagram of a method for awakening a network device shown according to an example. As shown in FIG. 8, the method includes:
step 801, an awakening signal from user equipment is received;
step 802, signal quality indication information of the awakening signal is determined; and
step 803, it is determined to awaken a second network device in response to a signal quality indicated by the signal quality indication information being greater than a set threshold; and
step 804, a dormant state is entered in response to not receiving an access message from the user equipment and/or no paging message to be sent within a second set time period after the second network device is awakened.

In an implementation, the awakening signal sent by the user equipment is received by the second network device, and the signal quality indication information of the awakening signal is determined. If the signal quality indicated by the signal quality indication information is greater than the set threshold, it indicates that a quality of a channel between the user equipment and the second network device is good, and thus it is determined to awaken the second network device. Furthermore, the dormant state is entered if the access message from the user equipment is not received and/or there is no paging message to be sent within the second set time period after the second network device is awakened.

A duration of the second set time period may be indicated by the first network device, or determined based on an agreement of a communication protocol, or determined by the second network device itself.

There may be a situation that the plurality of second network devices are awakened at the same time. If the user equipment accesses a cell through one of the awakened second network devices, there will be no other user equipment waiting to be served by the other awakened second network devices, so the other awakened second network devices enter the dormant state after the second set time.

In the above implementation, the first network device configures the transmit power for the user equipment to send the awakening signal to the second network device, and sends the configuration information to the user equipment. The user equipment sends the awakening signal based on the configured transmit power. Thus, the second network device can determine the quality of the channel between the second network device and the user equipment based on the awakening signal received from the user equipment, so as to determine whether the second network device is awakened.

An example of the disclosure provides an apparatus for awakening a network device. The apparatus is disposed on a first network device, and as shown in FIG. 9, includes:
a processing module 901, configured to determine configuration information, the configuration information including power parameter information; and
a transceiving module 902, configured to send the configuration information to user equipment;
where, the power parameter information is used for indicating transmit power at which the user equipment sends an awakening signal to N second network devices, N is a positive integer, and N is greater than or equal to 1.

In an implementation, the transceiving module 902 is further configured to:
send indication information to the second network devices, the indication information being used for indicating the power parameter information or set threshold information;
where, the set threshold information is used for determining whether to awaken the second network devices.

In an implementation, the processing module 901 is further configured to:
determine that the power parameter information includes M power parameters, M being a positive integer, and N being greater than or equal to M, M being greater than or equal to 1.

In an implementation, in response to M being equal to 1, the power parameter information is used for indicating that the user equipment uses the same transmit power when sending the awakening signal to the N second network devices; and

in response to N being greater than or equal to 2 and N is greater than or equal to M, M is greater than or equal to 2, the power parameter information is used for indicating that the user equipment uses different transmit power when sending the awakening signal to at least two second network devices.

In an implementation, the processing module 901 is further configured to:
determine, based on a coverage range of each of the N second network devices, the transmit power at which the user equipment sends the awakening signal to each second network device.

In an implementation, in response to that the awakening signal carries identity information of second network devices to be awakened, the power parameter information includes N power parameters, and the N power parameters are in one-to-one correspondence with the N second network devices;
where, the N power parameters are the same or different.

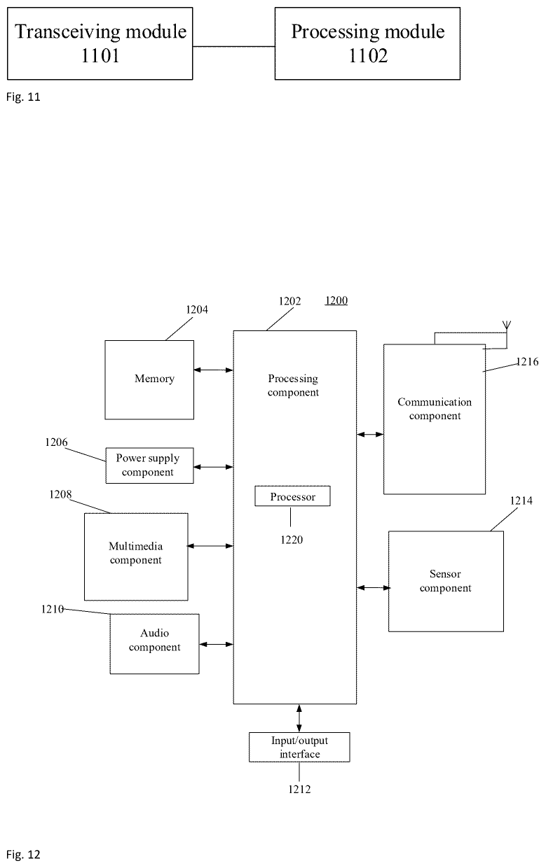

An example of the disclosure provides an apparatus for awakening a network device. The apparatus is disposed on user equipment, and as shown in FIG. 10, includes:
a transceiving module 1001, configured to receive configuration information from a first network device, the configuration information including power parameter information;
where, the power parameter information is used for indicating transmit power at which the user equipment sends an awakening signal to N second network devices, N is a positive integer, and N is greater than or equal to 1.

In an implementation, the transceiving module 1001 is further configured to:
send the awakening signal to at least one of the N second network devices based on the power parameter information.

In an implementation, the transceiving module 1001 is further configured to:
send the awakening signal to each of the at least one second network device for L times within a first set time period;
where, L is a positive integer, and L is greater than or equal to 2.

In an implementation, the power parameter information includes M power parameters, M is a positive integer, and N being greater than or equal to M, M being greater than or equal to 1.

In an implementation, the transceiving module 1001 is further configured to:
use the same transmit power when sending the awakening signal to the at least one second network device where that M is equal to 1; and
use different transmit power when sending the awakening signal to the at least two second network devices, where N is greater than or equal to 2, N is greater than or equal to M, M is greater than or equal to 2, and the at least one second network device are at least two second network devices.

In an implementation, the transceiving module 1001 is further configured to:
send, in response to that the awakening signal carries identity information of second network devices to be awakened, the awakening signal to the at least one second network device based on transmit power indicated by a power parameter corresponding to the at least one second network device.

An example of the disclosure provides an apparatus for awakening a network device. The apparatus is disposed on a second network device, and as shown in FIG. 11, includes:
a transceiving module 1101, configured to receive an awakening signal from user equipment; and
a processing module 1102, configured to determine signal quality indication information of the awakening signal, and determine to awaken the second network device in response to a signal quality indicated by the signal quality indication information being greater than a set threshold.

In an implementation, the transceiving module 1101 is further configured to:
receive indication information from a first network device, the indication information being used for indicating power parameter information or set threshold information;
where, the power parameter information is used for indicating transmit power at which the user equipment sends the awakening signal to the second network device.

In an implementation, the processing module 1102 is further configured to:
determine, in response to the indication information being used for indicating the power parameter information, the set threshold based on the power parameter information.

In an implementation, the transceiving module 1101 is further configured to:
receive L awakening signals sent by the user equipment within a first set time period;
where, L is a positive integer, and L is greater than or equal to 2.

In an implementation, the processing module 1102 is further configured to:
determine average signal quality indication information of the L awakening signals.

In an implementation, the processing module 1102 is further configured to:
enter into a dormant state in response to not receiving an access message from the user equipment and/or no paging message to be sent within a second set time period after the second network device is awakened.

An example of the disclosure provides a network side device, including:
one or more processors; and
a memory, configured to store executable instructions of the one or more processors;
where, the one or more processors are collectively configured to execute the executable instructions in the memory so as to implement steps of the method for awakening the network device above.

An example of the disclosure provides a mobile terminal, including:
one or more processors; and
a memory, configured to store executable instructions of the one or more processors;
where, the one or more processors are collectively configured to execute the executable instructions in the memory so as to implement steps of the method for awakening the network device above.

An example of the disclosure provides a network side device, including:
one or more processors; and
a memory, configured to store executable instructions of the one or more processors;
where, the one or more processors are collectively configured to execute the executable instructions in the memory so as to implement steps of the method for awakening the network device above.

An example of the disclosure provides a non-temporary computer-readable storage medium, which stores executable instructions, and the executable instructions, when executed by one or more processors, implement steps of the method for awakening the network device above.

FIG. 12 is a block diagram of an apparatus 1200 for awakening a network device shown according to an example. For example, the apparatus 1200 may be a mobile telephone, a computer, a digital broadcast terminal, a message transceiving device, a game console, a tablet device, a medical device, a fitness device, a personal digital assistant, and the like.

Referring to FIG. 12, the apparatus 1200 may include one or more of the following components: a processing component 1202, a memory 1204, a power supply component 1206, a multimedia component 1208, an audio component 1210, an input/output (I/O) interface 1212, a sensor component 1214, and a communication component 1216.

The processing component 1202 usually controls an overall operation of the apparatus 1200, such as operations associated with displaying, telephone calling, data communication, a camera operation and a record operation. The processing component 1202 may include one or more processors 1220 to execute instructions, so as to complete all or part of steps of the above method. In addition, the processing component 1202 may include one or more modules, so as to facilitate interaction between the processing component 1202 and other components. For example, the processing component 1202 may include a multimedia module, so as to facilitate interaction between the multimedia component 1208 and the processing component 1202.

The memory 1204 is configured to store various types of data so as to support operations on the apparatus 1200. Examples of these data include instructions of any application program or method used to be operated on the apparatus 1200, contact data, telephone directory data, messages, pictures, videos, and the like. The memory 1204 may be implemented by any type of volatile or nonvolatile storage device or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 1206 provides electric power for various components of the apparatus 1200. The power supply component 1206 may include a power management system, one or more power sources, and other components associated with generating, managing and distributing electric power for the apparatus 1200.

The multimedia component 1208 includes a screen providing an output interface between the apparatus 1200 and a user. In some examples, the screen may include a liquid crystal display (LCD) and a touch panel (TP). In response to determining that the screen includes the touch panel, the screen may be implemented as a touch screen so as to receive an input signal from the user. The touch panel includes one or more touch sensors to sense touching, swiping and gestures on the touch panel. The touch sensor may not only sense a boundary of a touching or swiping action, but also detect duration and pressure related to the touching or swiping operation. In some examples, the multimedia component 1208 includes a front camera and/or a back camera. When the apparatus 1200 is in an operation mode, such as a shooting mode or a video mode, the front camera and/or the back camera may receive external multimedia data. Each front camera and each back camera may be a fixed optical lens system or have a focal length and optical zooming capability.

The audio component 1210 is configured to output and/or input an audio signal. For example, the audio component 1210 includes a microphone (MIC). When the apparatus 1200 is in an operation mode, such as a call mode, a recording mode or a speech recognition mode, the microphone is configured to receive an external audio signal. The received audio signal may be further stored in the memory 1204 or sent via the communication component 1216. In some examples, the audio component 1210 further includes a speaker for outputting the audio signal.

The I/O interface 1212 provides an interface between the processing component 1202 and a peripheral interface module, and the above peripheral interface module may be a keyboard, a click wheel, buttons, etc. These buttons may include but are not limited to: a home button, a volume button, a start button and a lock button.

The sensor component 1214 includes one or more sensors for providing state evaluations of all aspects for the apparatus 1200. For example, the sensor component 1214 may detect an on/off state of the apparatus 1200 and relative positioning of components, for example, the components are a display and a keypad of the apparatus 1200. The sensor component 1214 may further detect position change of the apparatus 1200 or one component of the apparatus 1200, whether there is contact between the user and the apparatus 1200, azimuth or acceleration/deceleration of the apparatus 1200, and temperature change of the apparatus 1200. The sensor component 1214 may include a proximity sensor, which is configured to detect existence of a nearby object without any physical contact. The sensor component 1214 may further include an optical sensor, such as a CMOS or CCD image sensor, for use in an imaging application. In some examples, the sensor component 1214 may further include an acceleration sensor, a gyroscope sensor, a magnetic sensor, a pressure sensor or a temperature sensor.

The communication component 1216 is configured to facilitate wired or wireless communication between the apparatus 1200 and other devices. The apparatus 1200 may access a wireless network based on a communication standard, such as WiFi, 2G or 3G, or their combination. In one example, the communication component 1216 receives a broadcast signal or broadcast related information from an external broadcast management system via a broadcast channel. In an example, the communication component 1216 further includes a near-field communication (NFC) module so as to facilitate short-range communication. For example, the NFC module may be implemented based on a radio frequency identification (RFID) technology, an infrared data association (IrDA) technology, an ultra wide band (UWB) technology, a Bluetooth (BT) technology and other technologies.

In the example, the apparatus 1200 may be implemented by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements for executing the above method.

In the example, a non-temporary computer-readable storage medium including instructions is further provided, such as a memory 1204 including instructions. The above instructions may be executed by a processor 1220 of the apparatus 1200 so as to complete the above method. For example, the non-temporary computer-readable storage medium may be an ROM, a random access memory (RAM), a CD-ROM, a magnetic tape, a floppy disk, an optical data storage device and the like.

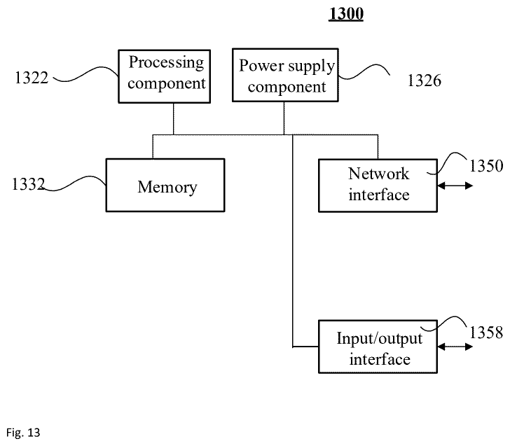

FIG. 13 is a block diagram of an apparatus 1300 for awakening a network device shown according to an example. For example, the apparatus 1300 may be provided as a base station. Referring to FIG. 13, the apparatus 1300 includes a processing component 1322, which further includes one or more processors, and a memory resource represented by a memory 1332, for storing instructions executable by the processing component 1322, such as an application program. The application program stored in the memory 1332 may include one or more modules with each corresponding to a set of instructions. In addition, the processing component 1322 is configured to execute the instructions to execute the above method for awakening the network device.

The apparatus 1300 may further include a power supply component 1326 configured to execute power management of the apparatus 1300, a wired or wireless network interface 1350 configured to connect the apparatus 1300 to a network, and an input/output (I/O) interface 1358. The apparatus 1300 may operate based on an operating system stored in a memory 1332, such as Windows Server™, Mac OS X™, Unix™, Linux™, FreeBSD™ or the like.

Those skilled in the art will easily figure out other implementation solutions of the examples of the disclosure after considering the specification and practicing the disclosure disclosed here. The present disclosure intends to cover any transformation, usage or adaptive change of the examples of the disclosure, and these transformations, usages or adaptive changes conform to a general principle of the examples of the disclosure and include common general knowledge or conventional technical means in the technical field not disclosed by the disclosure. The specification and the examples are regarded as being for example, and the true scope and spirit of the examples of the disclosure are indicated by the following claims.

It is to be understood that the examples of the disclosure are not limited to the exact structure that has been described above and shown in the accompanying drawings, and that various modifications and changes may be made without departing from the scope of the disclosure. The scope of the examples of the disclosure is limited by the appended claims.

### INDUSTRIAL APPLICABILITY

The first network device configures the transmit power for the user equipment to send the awakening signal to the second network devices, and sends the configuration information to the user equipment. The user equipment sends the awakening signal based on the configured transmit power. Thus, the second network device can determine the quality of the channel between the second network device and the user equipment based on the awakening signal received from the user equipment, so as to determine whether the second network device is awakened.

1. A method for awakening a network device, performed by a first network device, comprising:
determining configuration information, the configuration information comprising power parameter information; and
sending the configuration information to user equipment;
wherein, the power parameter information is used for indicating transmit power at which the user equipment sends an awakening signal to N second network devices, N is a positive integer, and N is greater than or equal to 1.

2. The method according to claim 1, further comprising:
sending indication information to the second network devices, the indication information being used for indicating the power parameter information or set threshold information;
wherein, the set threshold information is used for determining whether to awaken the second network devices.

3. The method according to claim 1, wherein determining the configuration information comprises:
determining that the power parameter information comprises M power parameters, M being a positive integer, and N being greater than or equal to M, M being greater than or equal to 1;
determining that M being equal to 1, the power parameter information is used for indicating that the user equipment uses the same transmit power when sending the awakening signal to the N second network devices; and
determining that N being greater than or equal to 2 and N is greater than or equal to M, M is greater than or equal to 2, the power parameter information is used for indicating that the user equipment uses different transmit power when sending the awakening signal to at least two second network devices.

4. (canceled)

5. The method according to claim 1, wherein determining configuration information comprises:
determining, based on a coverage range of each of the N second network devices, the transmit power at which the user equipment sends the awakening signal to each second network device.

6. The method according to claim 1, wherein
determining that the awakening signal carries identity information of second network devices to be awakened, the power parameter information comprises N power parameters, and the N power parameters are in one-to-one correspondence with the N second network devices;
wherein, the N power parameters are the same or different.

7. A method for awakening a network device, performed by user equipment, comprising:
receiving configuration information from a first network device, the configuration information comprising power parameter information;
wherein, the power parameter information is used for indicating transmit power at which the user equipment sends an awakening signal to N second network devices, N is a positive integer, and N is greater than or equal to 1.

8. The method according to claim 7, further comprising:
sending the awakening signal to at least one of the N second network devices based on the power parameter information.

9. The method according to claim 8, wherein sending the awakening signal to at least one of the N second network devices comprises at least one of:
sending the awakening signal to each of the at least one second network device for L times within a first set time period,
wherein, L is a positive integer, and L is greater than or equal to 2; or
sending, determining that the awakening signal carries identity information of second network devices to be awakened, the awakening signal to the at least one second network device based on transmit power indicated by a power parameter corresponding to the at least one second network device.

10. The method according to claim 8, wherein
the power parameter information comprises M power parameters, M is a positive integer, and N being greater than or equal to M, M being greater than or equal to 1;
wherein sending the awakening signal to at least one of the N second network devices comprises:
determining that M being equal to 1, the user equipment using the same transmit power when sending the awakening signal to the at least one second network device; and
determining that N being greater than or equal to 2, N being greater than or equal to M, M being greater than or equal to 2, and the at least one second network device being at least two second network devices, the user equipment using different transmit power when sending the awakening signal to the at least two second network devices.

11.-12. (canceled)

13. A method for awakening a network device, performed by a second network device, comprising:
receiving an awakening signal from user equipment;
determining signal quality indication information of the awakening signal; and
determining to awaken the second network device determining that a signal quality indicated by the signal quality indication information being greater than a set threshold.

14. The method according to claim 13, further comprising at least one of:
receiving indication information from a first network device, the indication information being used for indicating power parameter information or set threshold information,
wherein, the power parameter information is used for indicating transmit power at which the user equipment sends the awakening signal to the second network device,
entering into a dormant state determining that not receiving at least one of an access message from the user equipment or no paging message to be sent within a second set time period after the second network device is awakened.

15. The method according to claim 14, further comprising:
determining, determining that the indication information being used for indicating the power parameter information, the set threshold based on the power parameter information.

16. The method according to claim 13, wherein receiving an awakening signal from user equipment comprises:
receiving L awakening signals sent by the user equipment within a first set time period;
wherein, L is a positive integer, and L is greater than or equal to 2.

17. The method according to claim 16, wherein determining signal quality indication information of the awakening signal comprises:
determining average signal quality indication information of the L awakening signals.

18.-21. (canceled)

22. A network side device, comprising:
one or more processors; and
a memory, configured to store executable instructions of the one or more processors;
wherein, the one or more processors are collectively configured to execute the executable instructions in the memory so as to implement steps of the method for awakening the network device according to claim 1.

23. A mobile terminal, comprising:
one or more processors; and
a memory, configured to store executable instructions of the one or more processors;
wherein, the one or more processors are collectively configured to execute the executable instructions in the memory so as to implement steps of the method for awakening the network device according to claim 7.

24. A network side device, comprising:
one or more processors; and
a memory, configured to store executable instructions of the one or more processors;
wherein, the one or more processors are collectively configured to execute the executable instructions in the memory so as to implement steps of the method for awakening the network device according to claim 13.

25. A non-temporary computer-readable storage medium, storing executable instructions, the executable instructions, when executed by one or more processors, implementing steps of the method for awakening the network device according to claim 1.

26. A non-temporary computer-readable storage medium, storing executable instructions, the executable instructions, when executed by one or more processors, implementing steps of the method for awakening the network device according to claim 7.

27. A non-temporary computer-readable storage medium, storing executable instructions, the executable instructions, when executed by one or more processors, implementing steps of the method for awakening the network device according to claim 13.
